(19) United States
(12) Patent Application Publication
(10) Pub. No.: US 2018/0116453 A1
(43) Pub. Date: May 3, 2018

(54) KAMADO STYLE COOKER SYSTEM

(71) Applicant: GFMCO LLC dba Goldens' Foundry & Machine Company, Columbus, GA (US)

(72) Inventors: George Golden Boyd, Sr., Columbus, GA (US); George Golden Boyd, Jr., Columbus, GA (US); Edward Sprouse Boyd, Sr., Columbus, GA (US); John Thomas Boyd, II, Columbus, GA (US); John Toland, Columbus, GA (US); David Byrd, Phenix City, AL (US); Aurelio Hernandez, Phenix City, AL (US); Wallace Sims, JR., Phenix City, AL (US)

(21) Appl. No.: 15/795,423

(22) Filed: Oct. 27, 2017

Related U.S. Application Data
(60) Provisional application No. 62/414,381, filed on Oct. 28, 2016.

(51) Int. Cl. A47J 37/07; A47J 36/02; A47J 37/06

(52) U.S. Cl. CPC A47J 37/0704; A47J 37/0694; A47J 36/02

(57) ABSTRACT

A cast iron kamado style cooker system includes a cooker base and a cooker top hingedly connected to the cooker base. The cooker base includes a top end and a bottom end. The cooker base also includes a base cavity having a top opening at the top end, a side wall, and a bottom wall. The cast iron kamado style cooker system includes at least one support leg within the base cavity that extends inwardly from the side wall of the base cavity and upwardly from the bottom wall of the base cavity. The cooker top is hingedly connected to the cooker base.

### CROSS REFERENCE TO RELATED APPLICATION

The present application claims the benefit of U.S. Provisional Patent Application No. 62/414,381 entitled “KAMADO STYLE COOKER SYSTEM” and filed on Oct. 28, 2016, the disclosure of which is hereby incorporated by reference in its entirety.

### FIELD OF THE INVENTION

Embodiments of the invention relate to cooker systems, and more particularly to cast iron kamado style cooker systems.

### BACKGROUND

A kamado cooker is a traditional Japanese wood or charcoal fueled cook stove. Modern versions of the cooker are believed to derive from clay vessels used by humans to cook food for many thousands of years. A common fault in the original Japanese design is that clay and ceramic materials tend to crack over time. Modern ceramic and refractory materials decrease cracking only to some extent, and Portland cement is still associated with cracking problems. Accordingly, a shortcoming of modern Kamado-style cookers is their lack of strength and durability because of the use of ceramic and refractory lining materials.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to various embodiments, a kamado style cooker system includes a cooker base and a cooker top hingedly connected to the cooker base. The cooker base defines a base cavity and includes at least one support leg within the base cavity.

In certain embodiments, the cooker base and the cooker top are each monolithically formed from cast iron. In some embodiments, the kamado style cooker system includes a firebox housing removably positioned on the at least one support leg within the base cavity. In various aspects, the firebox housing includes a top end having a top opening and a bottom end having a bottom opening. A central aperture extends from the top opening to the bottom opening. In some examples, a diameter of the top opening is greater than a diameter of the bottom opening. According to certain embodiments, the system includes a firebox insert having a plurality of insert apertures. The firebox insert is removably positioned within the central aperture of the firebox housing and on the at least one support leg within the base cavity. In some embodiments, the at least one support leg includes a first ledge and a second ledge horizontally offset below the first ledge. The firebox housing is removably positioned on the first ledge and the firebox insert is removably positioned on the second ledge.

According to various examples, the cooker base includes a top end and a bottom end, and the top end includes a cooker base opening providing access to the base cavity. In certain examples, the cooker base includes a grate ledge within the base cavity between the top end and the bottom end. In some embodiments, a grate is removably supported on the grate ledge. In various aspects, the grate includes a plurality of legs removably positioned on the grate ledge such that a cooking surface of the grate is flush with the top end of the cooker base.

In various embodiments, the at least one support leg comprises a plurality of support legs. In some embodiments, the base cavity includes a side wall and a bottom wall, and the at least one support leg extends inwardly from the side wall and upwardly from the bottom wall. According to certain embodiments, the at least one support leg extends upwardly from the bottom wall a predetermined distance that is less than a distance from the bottom wall to a top end of the cooker base. In some cases, the at least one support leg includes a first ledge and a second ledge horizontally offset below the first ledge, and the second ledge is at a horizontal position above a base draft opening of the cooker base.

According to certain embodiments, a cast iron kamado style cooker system includes a monolithic cooker base and at least one support leg. The monolithic cooker base includes a top end, a bottom end, and a base cavity. The base cavity includes a top opening at the top end, a side wall, and a bottom wall. The at least one support leg is positioned within the base cavity and extends inwardly from the side wall of the base cavity and upwardly from the bottom wall of the base cavity. In some examples, the at least one support leg extends upwardly a predetermined distance that is less than a distance from the bottom wall to the top end of the cooker base.

In various embodiments, the system includes a monolithic cooker top hingedly attached to the cooker base. The cooker top includes a top end and a bottom end. In certain aspects, the system includes a firebox housing removably positioned within the base cavity on the at least one support leg and a firebox insert removably positioned within the base cavity, within the firebox housing, and on the at least one support leg.

In some embodiments, the at least one support includes a first ledge and a second ledge horizontally offset below the first ledge. In certain cases, the firebox housing is positioned on the first ledge and the firebox insert is removably positioned on the second ledge. In certain aspects, the at least one support leg includes a plurality of support legs spaced equidistantly along the side wall. In various embodiments, the predetermined distance is a horizontal position above a base draft opening of the cooker base. In certain aspects, the system includes a grate, and the cooker base includes a grate ledge within the base cavity between the top end and the bottom end. In some examples, the grate is removably positioned on the grate ledge such that a cooking surface of the grate is flush with the top end of the cooker base.

Various implementations described in the present disclosure can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures can be designated by matching reference characters for the sake of consistency and clarity.

FIG. 1 is a top perspective view of a kamado style cooker system according to aspects of the current disclosure.

FIG. 2 is a top perspective view of a cooker base of the kamado style cooker system of FIG. 1 according to aspects of the current disclosure.

FIG. 3 is a top plan view of the cooker base of FIG. 2.

FIG. 4 is a side elevation view of the cooker base of FIG. 2.

FIG. 5 is a top perspective view of a cooker top of the kamado style cooker system of FIG. 1 according to aspects of the current disclosure.

FIG. 6 is a top plan view of the cooker top of FIG. 5.

FIG. 7 is a bottom plan view of the cooker top of FIG. 5.

FIG. 8 is a side elevation view of the cooker top of FIG. 5.

FIG. 9 is a top perspective view of an embodiment of a firebox housing for use with the kamado style cooker system of FIG. 1 according to aspects of the current disclosure.

FIG. 10 is a top plan view of the firebox housing of FIG. 9.

FIG. 11 is a side elevation view of the firebox housing of FIG. 9.

FIG. 12 is a top perspective view of an embodiment of a firebox insert for use with the kamado style cooker system of FIG. 1 according to aspects of the current disclosure.

FIG. 13 is a top perspective view of an embodiment of a cooker grate for use with the kamado style cooker system of FIG. 1 according to aspects of the current disclosure.

FIG. 14 is a side elevation view of the cooker grate of FIG. 13.

FIG. 15 is a top perspective view of the cooker top of FIG. 5 connected to the cooker base of FIG. 2 and in an open configuration.

FIG. 16 is a top perspective view of the cooker base of FIG. 2.

FIG. 17 is a top perspective view of the firebox housing of FIG. 9 positioned within the cooker base of FIG. 2.

FIG. 18 is a top perspective view of the firebox housing of FIG. 9 and the firebox insert of FIG. 12 positioned within the cooker base of FIG. 2.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down,” “top,” “left,” “right,” “front,” and “back,” among others are intended to refer to the orientation as illustrated and described in the figure (or figures) to which the components and directions are referencing.

Embodiments of the present invention relate to cast iron kamado style cookers. According to certain embodiments, the cast iron kamado style cooker includes a cooker base with a hingedly attached cooker top. The cast iron kamado style cooker is based on a traditional Japanese wood or charcoal fueled cook stove, but unlike traditional Japanese cook stoves or modern kamado style cookers, the cooker base is monolithically or integrally formed. In some embodiments, the cooker top is also monolithically or integrally formed. A base vent is provided in the cooker base and a top vent is provided in the cooker top to provide air to a fuel source, such as charcoal, within the cooker base. The temperature within the cast iron kamado style cooker may be controlled by adjusting the base vent and/or the top vent. One or more cooker grates may be suspended within the cast iron kamado style cooker to provide a cooking surface for food.

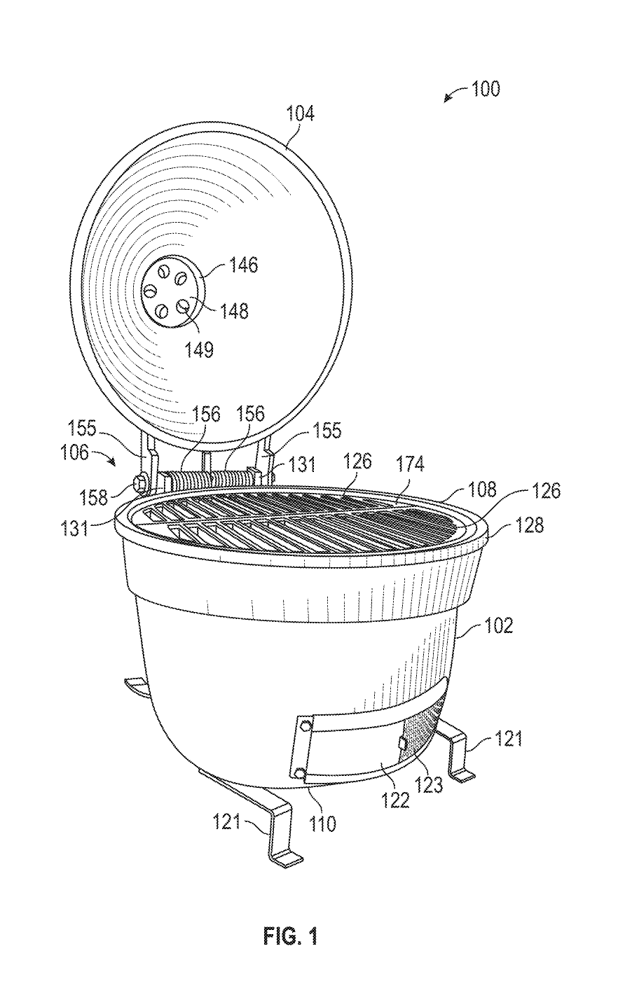

FIG. 1 illustrates an embodiment of a kamado style cooker 100. The cooker 100 includes a cooker base 102 and a cooker top 104 hingedly connected to a cooker base 102 through a hinge mechanism 106. The cooker base 102 and cooker top 104 may each be integrally or monolithically formed from cast iron. In other examples, other suitable materials may be used to form the cooker 100. An outermost diameter of the assembled cooker 100 can be of any diameter, including diameters of 12 inches and larger (e.g., 14 inches). In other examples, the assembled cooker 100 may have a diameter less than 12 inches.

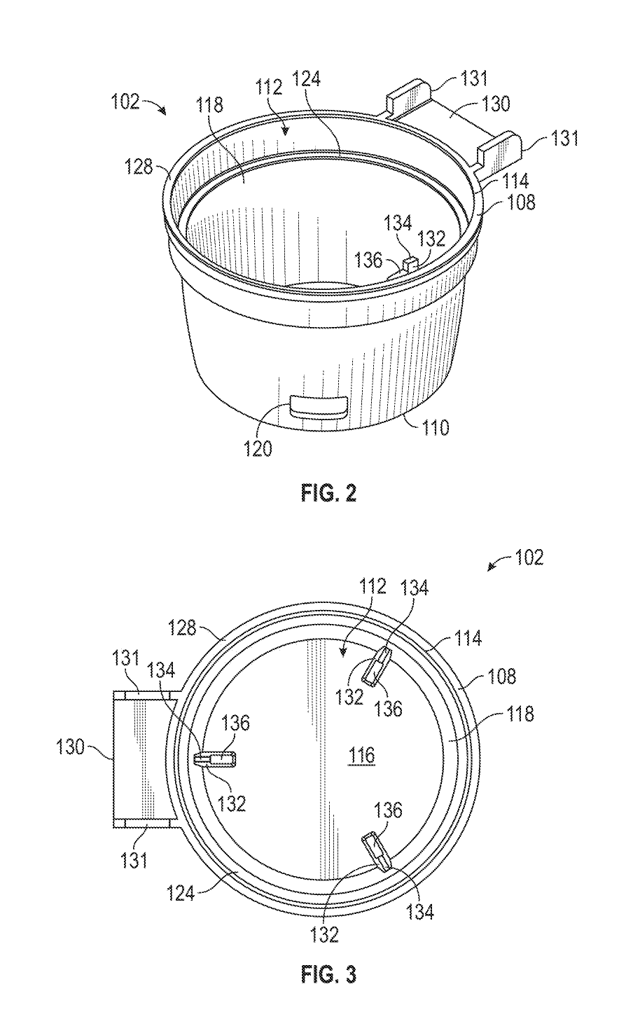

Referring to FIGS. 1-4, the cooker base 102 includes a top end 108 and a bottom end 110. The cooker base 102 defines a base cavity 112 having a top opening 114 at the top end 108. The base cavity 112 includes a bottom wall 116 opposite the top opening 114 and a side wall 118, although the shape of the base cavity 112 should not be considered limiting on the current disclosure. In some examples, a base draft opening 120 extends through the cooker base 102 and allows for air flow through the base draft opening 120 (see FIG. 2). In some examples, a controllable vent cover 122 having an adjustable vent cover opening 123 is provided to control the amount or rate of air allowed through the base draft opening 120 (which can be used to control a temperature within the cooker 100). The vent cover opening 123 is aligned with the base draft opening 120, and the amount of air allowed through the vent cover opening 123 (and thus the base draft opening 120) can be controlled. In various examples, the base draft opening 120 permits air to enter the cooker base 102 and fuel the fire in the cooker base 102 (e.g., in a firebox housing 138, discussed below).

In various embodiments, at least one support leg 132 is provided within the base cavity 112 for supporting the firebox housing 138 and a firebox insert 140. For example, three support legs 132 are illustrated in FIG. 3, although any number of support legs 132 may be provided. In certain examples, at least two support legs 132 are positioned within the cooker base 102. While the support legs 132 may be formed as separate components that are subsequently mounted within the cooker base 102, in some embodiments the support legs 132 are formed integrally with the cooker base 102.

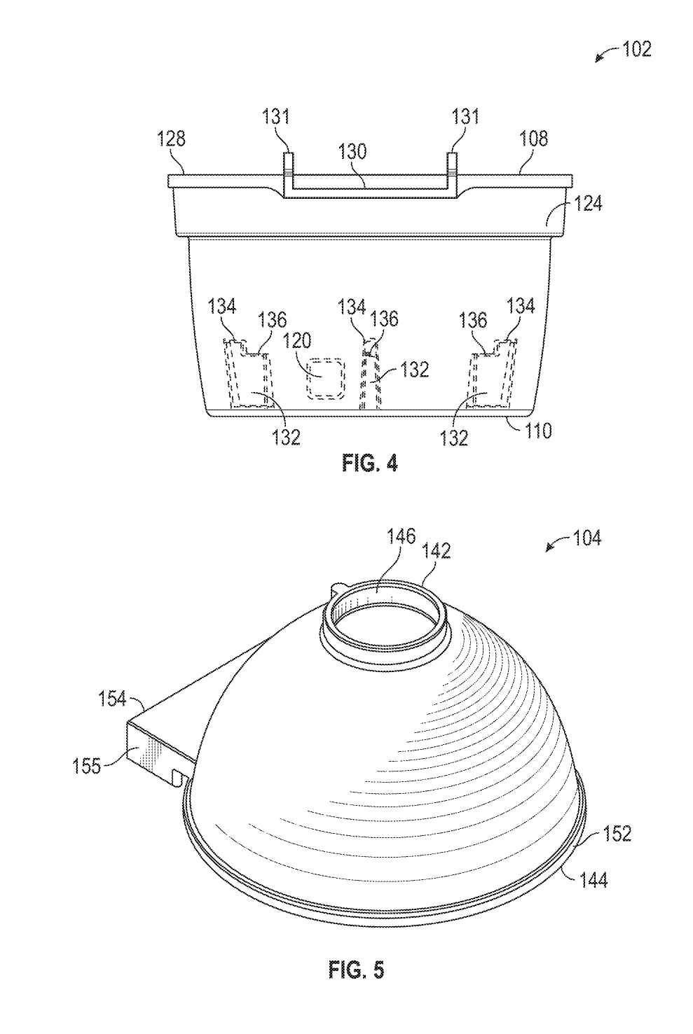

When positioned within the base cavity 112, the support legs 132 extend inwardly from the side wall 118 and/or upwardly from the bottom wall 116. In some examples with a plurality of support legs 132, the support legs 132 may be spaced equidistantly along the side wall 118, although they need not be. In some examples, the support legs 132 extend upwardly a predetermined distance from the bottom wall 116. In various embodiments, the predetermined distance is less than a distance from the bottom wall 116 to the top end 108. In certain embodiments, the support legs 132 extend upwardly such that a first ledge 134 of each support leg 132 extend above the base draft opening 120 (see the support legs 132 shown in phantom in FIG. 4). In some cases, the support legs 132 include a second ledge 136 that is horizontally offset below the first ledge 134. Optionally, the second ledge 136 extend above the base draft opening 120. In various embodiments, the firebox housing 138 is supported on the first ledge 134 and the firebox insert 140 is supported on the second ledge 136. The support legs 132 may have any shape so long as the support legs 132 can support the desired component(s) within the cooker base 102.

In some embodiments, the cooker base 102 includes a grate ledge 124 within the base cavity 112 between the bottom wall 116 and the top opening 114. The grate ledge 124 extends within the cooker base 102 at least partially around the circumference of the side wall 118 so as to support at least one grate 126 (see FIG. 1). In some embodiments, the grate ledge 124 is not a continuous ledge but rather grate ledge 124 segments are provided. In some examples, a diameter of the top opening 114 is greater than a diameter of the grate ledge 124. In various embodiments, the diameter of the grate ledge 124 may be greater than a diameter of the bottom wall 116, although it need not be. In some embodiments, a circumferential band 128 is formed integrally with the cooker base 102. More specifically, the band 128 extends around top end 108 of the cooker base 102.

A hinge plate 130 is preferably formed integrally with the cooker base 102, although it need not be. In some embodiments, the hinge plate 130 is formed integrally with the circumferential band 128 on the cooker base 102. Thus, in some embodiments, the circumferential band 128 and the hinge plate 130 are formed integrally (cast as a single piece) with the cooker base 102. In other embodiments, the hinge plate 130 may be formed separately and subsequently attached at any suitable location on the cooker base 102. In the illustrated embodiments, the hinge plate 130 on the cooker base 102 includes upwardly extending flanges 131. As described below, the hinge mechanism 106 may engage the hinge plate 130 to assist with opening and closing of the cooker top 104 relative to the cooker base 102.

Optionally, the cooker base 102 may include feet 121 or other suitable supports for supporting the cooker 100. In some cases, wheels may be included with the feet. In other embodiments, a cart may be provided, and the cooker 100 is supported on the cart.

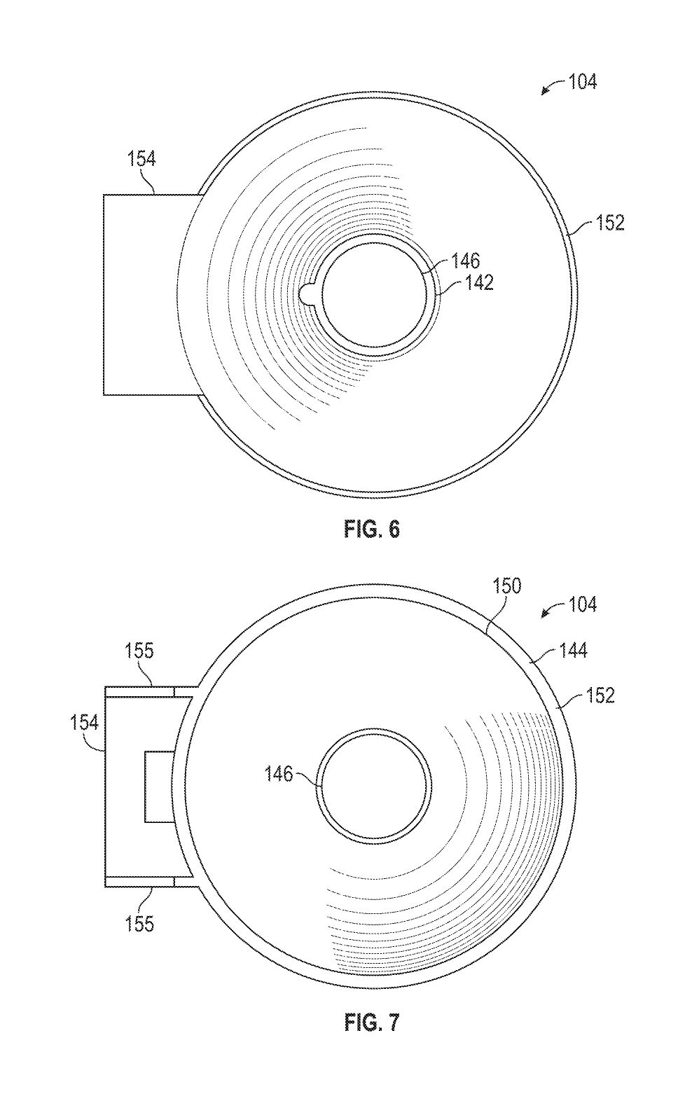

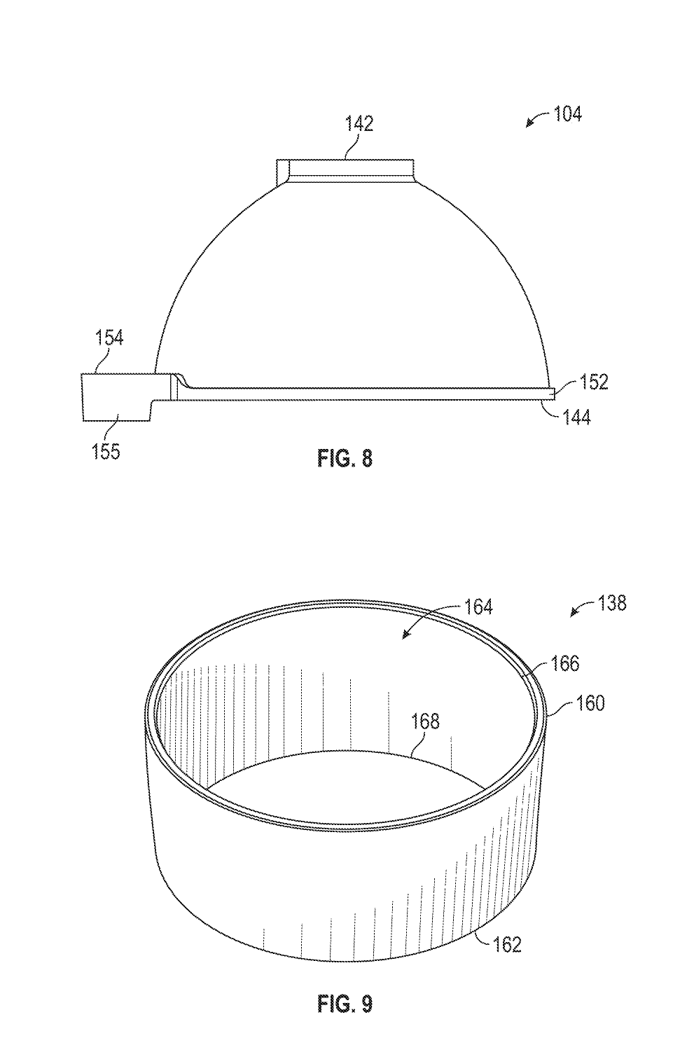

Referring to FIGS. 1 and 5-8, the cooker top 104 has a top end 142 and a bottom end 144. In some examples, the cooker top 104 includes a top draft opening 146 at the top end 142. Similar to the base draft opening 120, a controllable vent cover 148 (see FIG. 1) having an adjustable vent cover opening 149 may be provided to control the amount or rate of air allowed through the top draft opening 146 (which can be used to control a temperature within the cooker 100). The adjustable vent cover opening 149 is aligned with the top draft opening 146, and the amount of air allowed through the vent cover opening 149 (and thus the top draft opening 148) can be controlled. In various embodiments, the top draft opening 146 permits air to exit the cooker 100.

A bottom opening 150 is provided at the bottom end 144 of the cooker top 104. In various examples, a diameter of the bottom opening 150 is the same as the diameter of the top opening 114, although it need not be. Similar to the cooker base 102, the cooker top 104 may include a circumferential band 152 formed integrally with the cooker top 104. More specifically, the band 152 extends around bottom end 144 of the cooker top 104.

A gasket (not shown) may be mounted on the contact surfaces formed by the bands 128, 152. The gasket is formed of a material that does not burn, melt, or otherwise degrade when exposed to the excessive heat of the cooker. Flame resistant materials such as meta-aramid materials (e.g., Nomex) are particularly suitable in such applications. The bands create a contact surface of sufficient thickness such that, when the cooker top 104 is closed so as to seat on the cooker base 102, the contact surfaces of the opposing bands 128, 152 (with associated gaskets) contact to form a tight seal.

Similar to the cooker base 102, the cooker top 104 may include a hinge plate 154 formed integrally with the cooker top 104, although it need not be. In some embodiments, the hinge plate 154 is formed integrally with the circumferential band 152 on the cooker top 104. Thus, in some embodiments, the circumferential band 152 and the hinge plate 154 are formed integrally (cast as a single piece) with the cooker top 104. In other embodiments, the hinge plate 154 may be formed separately and subsequently attached at any suitable location on the cooker top 104. The hinge plate 154 on the cooker top 104 includes downwardly extending flanges 155 that at least partially overlap with the upwardly extending flanges 131 when the cooker top 104 is positioned on the cooker base 102.

Referring to FIG. 1, the hinge mechanism 106 may engage the hinge plates 130 and 154 to assist with opening and closing of the cooker top 104 relative to the cooker base 102. In one embodiment, the hinge mechanism 106 includes one or more torsion springs 156 installed on a hinge pin 158 that extends between the overlapping hinge plates 130, 154. The spring(s) 156 bias the hinge plates 130, 154 toward an open configuration during lifting. An example of a cast iron kamado style cooker with this and other hinge mechanisms is disclosed in U.S. application Ser. No. 14/985,852, filed Dec. 31, 2015 (the '852 application), the content of which is hereby incorporated by reference in its entirety.

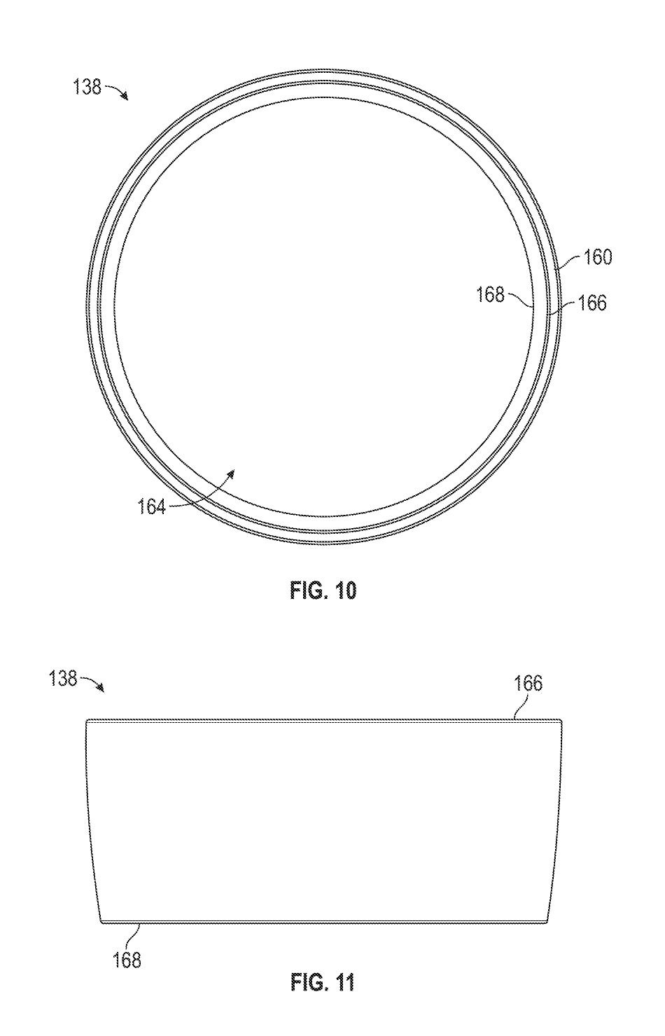

In various embodiments, the cooker 100 includes the firebox housing 138. The firebox housing 138 is removably positioned within the base cavity 112, meaning that the firebox housing 138 may be inserted or removed as desired. As illustrated in FIGS. 9-11, the firebox housing 138 includes a top end 160 and a bottom end 162. A central aperture 164 extends through the firebox housing 138 from a top opening 166 at the top end 160 to a bottom opening 168 at the bottom end 162. In some examples, a diameter of the top opening 166 is greater than a diameter of the bottom opening 168, although it need not be.

In some embodiments, the cooker 100 includes the firebox insert 140. In various examples, the firebox insert 140 is a separate component from the firebox housing 138 such that different firebox inserts 140 (e.g., inserts 140 having different numbers, sizes, shapes, locations, etc. of apertures) may easily be substituted within the cooker 100 to tailor and adjust the heat and cooking profile of the cooker 100. Alternatively, in other embodiments, the firebox housing 138 and firebox insert 140 may be integrally or monolithically formed as a unitary component.

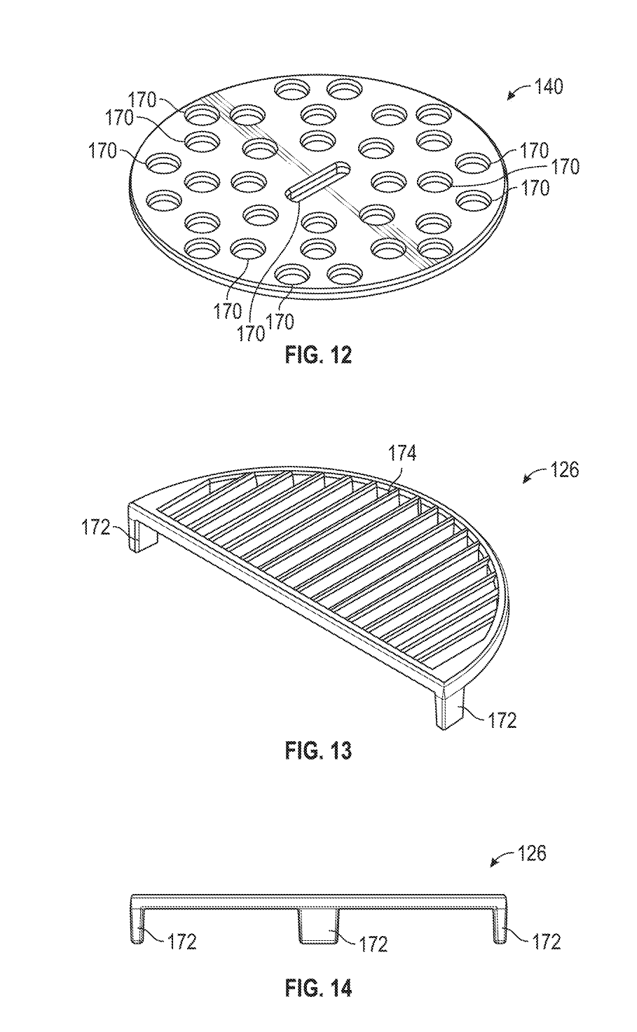

As illustrated in FIG. 12, the firebox insert 140 includes a plurality of apertures 170. The firebox insert 140 is removably positioned within the base cavity 112. In various examples, a diameter of the firebox insert 140 is less than the diameter of the top opening 166 and/or the bottom opening 168 of the firebox housing 138. When assembled within the base cavity 112, the firebox insert 140 may support charcoal within the base cavity 112 at a distance from the bottom wall 116 while allowing air to pass through the apertures 170 in the firebox insert 140 after entering the cooker 100 via the base draft opening 120 to reach the fire burning in the firebox housing 138.

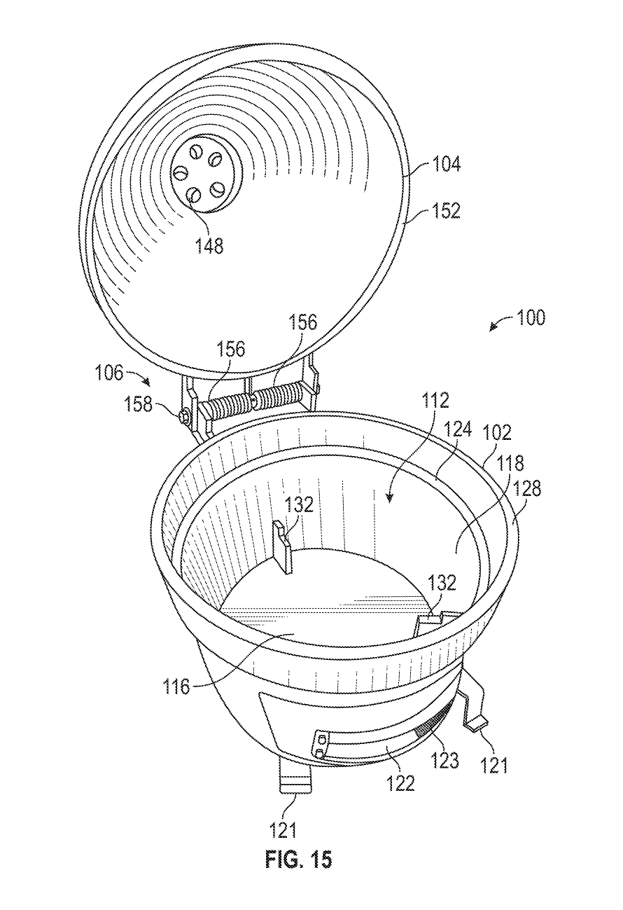

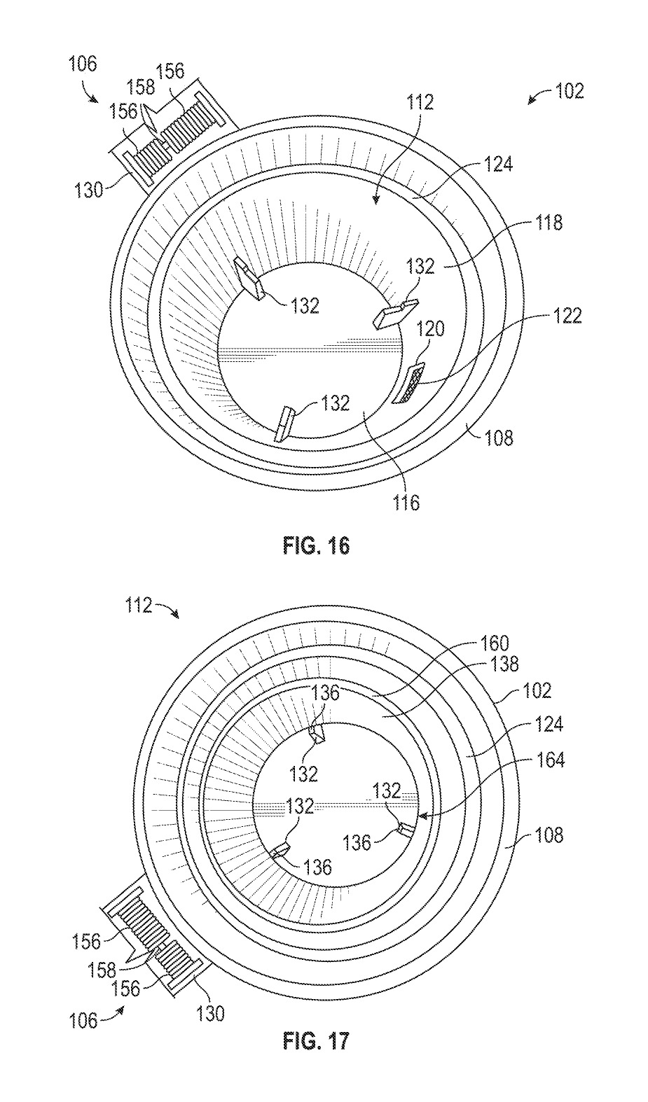

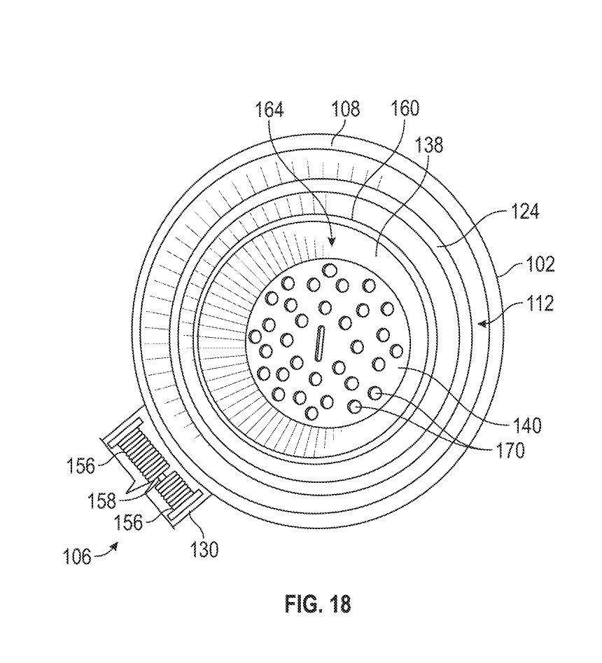

The firebox housing 138 and firebox insert 140 support cooking fuel (e.g., charcoal, wood, etc.) within the cooker 100. Referring to FIGS. 15-18, the firebox insert 140 is positioned within the base cavity 112 so as to rest on the support legs 132. In certain examples, the firebox insert 140 is positioned on the second ledges 136 if the support legs 132 have the stepped profile. The firebox housing 138 may be seated on the first ledges 134, on the second ledges 136, or atop the firebox insert 140 resting on the second ledges 136. In this way, the support legs 132 support the firebox (firebox housing 138 and insert 140) within the cooker bottom.

One or more grates 126 may be provided with the cooker 100. The grates 126 may be suspended within the cooker 100 to provide a cooking surface 174 for the food. Optionally, the grates 126 include feet 172 that are removably positioned on the grate ledge 124 of the cooker base 102. Optionally, the feet 172 have a predetermined height (and/or the grate ledge 124 is a predetermined distance from the top end 108 of the cooker base 102) such that when the grates 126 are suspended within the cooker 100, the cooking surface 174 is substantially flush with the top end 108 (see, e.g., FIG. 1).

One or more handles (not shown) may be provided on one or both of the cooker base 102 and cooker top 104. The handles may be formed integrally with the cooker base 102 and/or top 104 or may be separate from, but attached to, the cooker base 102 and/or top 104. The one or more handles may be located anywhere on the cooker 100 (e.g., front, sides, etc.).

While not required, in some embodiments, the features of the cooker described herein are all formed of cast iron. However, they may be formed from other suitable materials as well.

Different arrangements of the components depicted in the drawings or described above, as well as components and steps not shown or described are possible. Similarly, some features and sub-combinations are useful and may be employed without reference to other features and sub-combinations. Examples of the invention have been described for illustrative and not restrictive purposes, and alternative examples will become apparent to readers of this patent. Accordingly, the present invention is not limited to the examples described above or depicted in the drawings, and various examples and modifications may be made without departing from the scope of the claims below.

That which is claimed:

1. A kamado style cooker system comprising:
a cooker base defining a base cavity and comprising at least one support leg within the base cavity; and
a cooker top hingedly connected to the cooker base.

2. The kamado style cooker system of claim 1, wherein the cooker base is monolithically formed from cast iron, and wherein the cooker top is monolithically formed from cast iron.

3. The kamado style cooker system of claim 1, further comprising a firebox housing removably positioned on the at least one support leg within the base cavity, wherein the firebox housing comprises a top end having a top opening and a bottom end having a bottom opening, wherein a central aperture extends from the top opening to the bottom opening.

4. The kamado style cooker system of claim 3, wherein a diameter of the top opening is greater than a diameter of the bottom opening.

5. The kamado style cooker system of claim 3, further comprising a firebox insert comprising a plurality of insert apertures, wherein the firebox insert is removably positioned within the central aperture of the firebox housing and on the at least one support leg within the base cavity.

6. The kamado style cooker system of claim 5, wherein the at least one support leg comprises a first ledge and a second ledge horizontally offset below the first ledge, and wherein the firebox housing is removably positioned on the first ledge and the firebox insert is removably positioned on the second ledge.

7. The kamado style cooker system of claim 1, wherein the cooker base comprises a top end and a bottom end, wherein the top end comprises a cooker base opening providing access to the base cavity, and wherein the cooker base further comprises a grate ledge within the base cavity between the top end and the bottom end.

8. The kamado style cooker system of claim 7, further comprising a grate removably supported on the grate ledge.

9. The kamado style cooker system of claim 8, wherein the grate comprises a plurality of legs removably positioned on the grate ledge such that a cooking surface of the grate is flush with the top end of the cooker base.

10. The kamado style cooker system of claim 1, wherein the at least one support leg comprises a plurality of support legs.

11. The kamado style cooker system of claim 1, wherein the base cavity comprises a side wall and a bottom wall, and wherein the at least one support leg extends inwardly from the side wall and upwardly from the bottom wall.

12. The kamado style cooker system of claim 11, wherein the at least one support leg extends upwardly from the bottom wall a predetermined distance that is less than a distance from the bottom wall to a top end of the cooker base.

13. The kamado style cooker system of claim 11, wherein the at least one support leg comprises a first ledge and a second ledge horizontally offset below the first ledge, wherein the cooker base comprises a base draft opening, and wherein the second ledge is at a horizontal position above the base draft opening of the cooker base.

14. A cast iron kamado style cooker system comprising:
a monolithic cooker base comprising:
a top end;
a bottom end; and
a base cavity having a top opening at the top end and comprising a side wall and a bottom wall; and
at least one support leg with the base cavity, wherein the at least one support leg extends inwardly from the side wall of the base cavity and upwardly from the bottom wall of the base cavity,
wherein the at least one support leg extends upwardly a predetermined distance that is less than a distance from the bottom wall to the top end of the cooker base.

15. The cast iron kamado style cooker system of claim 14, further comprising a monolithic cooker top hingedly attached to the cooker base.

16. The cast iron kamado style cooker system of claim 14, further comprising:
a firebox housing removably positioned within the base cavity on the at least one support leg; and
a firebox insert removably positioned within the base cavity, within the firebox housing, and on the at least one support leg.

17. The cast iron kamado style cooker system of claim 16, wherein the at least one support comprises a first ledge and a second ledge horizontally offset below the first ledge, wherein the firebox housing is positioned on the first ledge, and wherein the firebox insert is removably positioned on the second ledge.

18. The cast iron kamado style cooker system of claim 14, wherein the at least one support leg comprises a plurality of support legs spaced equidistantly along the side wall.

19. The cast iron kamado style cooker system of claim 14, wherein the predetermined distance is a horizontal position above a base draft opening of the cooker base.

20. The cast iron kamado style cooker system of claim 14, further comprising a grate, wherein the cooker base further comprises a grate ledge within the base cavity between the top end and the bottom end, and wherein the grate is removably positioned on the grate ledge such that a cooking surface of the grate is flush with the top end of the cooker base.
